(19) United States
(12) Patent Application Publication
(10) Pub. No.: US 2006/0217967 A1
(43) Pub. Date: Sep. 28, 2006

(54) System and methods for storing and presenting personal information

(76) Inventors: Doug Goertzen, New Westminster (CA); David Kauffman, Vancouver (CA)

Correspondence Address: PATENT LEGAL STAFF, EASTMAN KODAK COMPANY, 343 STATE STREET, ROCHESTER, NY, 14650-2201, US

(21) Appl. No.: 10/549,514

(22) PCT Filed: Mar. 22, 2004
(86) PCT No.: PCT/CA04/00426

§ 371 Date: Sep. 20, 2005

Related U.S. Application Data
(60) Provisional application No. 60/456,934, filed on Mar. 20, 2003.
(60) Provisional application No. 60/477,022, filed on Jun. 10, 2003.

(51) Int. Cl. G10L 19/00

(52) U.S. Cl. 704/201

(57) ABSTRACT

A user can interact with a portable device (10, 10A) to store and receive information using a voice-driven interface. Single utterance spoken commands can be used to perform functions such as making calendar entries, generating reminders, generating ToDo items and the like. A portable device (10, 10A) may automatically identify devices which are nearby at the time of an event and store a list of those other devices. Speech recognition and speech synthesis may be performed at a computer system which is remote from the portable device. The portable device may be in only sporadic communication with the computer system.

### CROSS-REFERENCE TO RELATED APPLICATIONS

This application claims the benefit of U.S. application No. 60/456,934 entitled SYSTEM AND METHOD FOR PROVIDING PROXIMITY BASED CONTEXT INFORMATION filed on 20 Mar. 2003 and U.S. application No. 60/477,022 entitled WIRELESS CALENDAR SYNCHRONIZATION filed on 10 Jun. 2003 both of which are hereby incorporated by reference herein.

### TECHNICAL FIELD

This invention is in the field of portable electronic devices which provide users with access to information such as memos and calendar functions. The invention may be applied to providing voice controlled portable electronic devices.

### BACKGROUND

A personal digital assistant (“PDA”) is a small electronic device that can be used to store and retrieve personal information, such as information about a person's calendar, e-mail, notes and memoranda, and the like. A wide range of PDAs are currently available. One problem is that a PDA should be small so that it is easily portable. However, providing a small user interface which can be used comfortably to enter information into a PDA is very difficult. Small keyboards are awkward to use.

Another problem that is becoming increasingly significant is managing and finding stored data. Devices for capturing or generating digital information are proliferating. Devices such as digital sound recorders, digital cameras, calendars, personal digital assistants can all be used to generate digital information. It is relatively easy to amass hundreds of digital pictures, notes, stored music, digital voice memos, etc. This tends to make it very difficult to find a particular piece of information. A method of navigating through large amounts of data is to use contextual information, such as time or location to assist the search.

Maintaining synchronization between data stored in different devices poses another problem. Calendar software provides a mechanism for keeping track of events. Typical calendar software permits a user to enter information about upcoming events. The user may enter, for example, the date and time, duration and subject matter for each event. The user can view the calendar to see the times of scheduled events and to identify times when no events have been scheduled.

iCal™ software available from Apple Computer, Inc. is an example of calendar software. The iCal software provides separate color-coded calendars which can be used to track different types of event. Three of the iCal calendars could be used, for example, to track home, school and work schedules. The iCal software permits a user to view all of the user's different calendars at the same time from within a single unified window. This view permits scheduling conflicts to be identified quickly. The current version of Microsoft™ Outlook™ has similar features.

Portable computing devices such as personal digital assistants (PDAs) can run calendar software. It is typical to keep the calendar in a PDA or other portable device synchronized with a master calendar maintained on a server or desktop computer. To achieve this end, the portable device is connected periodically to communicate with the master calendar. Synchronization involves downloading calendar information from the master calendar to the portable device and/or uploading calendar information from the portable device to the master calendar. After synchronization the calendar in the portable device and the master calendar contain entries for the same events.

Synchronization is often performed between a portable device and a network-connected personal computer (PC) which is in data communication with a centralized server using a communications protocol such as POP, IMAP or Microsoft's Exchange™. In normal operation, the user connects the portable device to the PC, using a cable, infrared, or wireless link and initiates a request to synchronize the devices. For portable devices that are capable of creating and editing appointments, the synchronizing software needs to identify conflicts and may resolve the conflicts or escalate them to the user for resolution.

There is a need for systems and methods of managing information which ameliorate one or more of the above-noted problems.

### SUMMARY

This invention provides systems which include or interact with portable electronic devices. The portable electronic devices can deliver and/or accept information from a user.

One aspect of the invention provides methods and apparatus for entering data into calendars, reminder systems, and the like using voice commands delivered at portable devices. Some embodiments accept voice commands in the form of single utterances.

Another aspect of the invention provides a method for recording and confirming a transaction. The transaction may, for example, comprise a calendar entry for a meeting, telephone conference or the like, a reminder to be given, or the like. The method comprises at a portable device, storing speech data comprising a spoken command and performing speech recognition on the speech data. Subsequently, in response to an output of the speech recognition the method records a transaction corresponding to the spoken command at a database in a computer system remote from the portable device; and, transmits control information and descriptive data corresponding to the transaction to the portable device. At a time, or location, or combination of time and location determined by the control information, the method reproduces sound determined by the descriptive data at the portable device. The sound may comprise speech.

Another aspect of the invention provides a method for controlling a function provided at least in part by way of a portable electronic device. The method comprises: at a portable device obtaining speech data by receiving and digitizing a spoken command the command comprising a request to generate an event at the portable device and transferring the speech data to a computer system. At the computer system, the method performs speech recognition on the speech data; based upon a result of the speech recognition, identifies at least a desired trigger for an event; and, generates control data corresponding to the desired trigger. The method transfers the control data from the computer system to the portable device and, on the occurrence of a trigger specified by the control data, provides an audible signal by way of the speaker of the portable device. The audible signal may comprise digitized speech downloaded from the computer system.

Another aspect of the invention provides a method for automatically associating context information with an event. The method comprises: at a portable device comprising a wireless data transceiver, recording an event; in response to recording the event, saving a list of other devices detected by way of the wireless data transceiver and associating the list with the recorded event.

Another aspect of the invention provides a method for maintaining calendar data in a computer-based calendar. The method comprises: at a portable device comprising: a microphone; a digitizer coupled to receive and digitize speech signals captured by the microphone; and, a speaker; receiving and digitizing a spoken command. The command comprises a request to add data to a computer-based calendar. The method performs speech recognition on the spoken command and continues by: based upon a result of the speech recognition, identifying at least a time for an event and entering the time for the event as calendar data in a computer calendar; and, at the time for the event providing an audible signal by way of the speaker of the portable device. The audible signal may comprise digitized speech. The digitized speech may be synthesized at a computer system and downloaded to the portable device.

Another aspect of the invention provides apparatus for controlling a function provided at least in part by way of a portable electronic device. The apparatus comprises a portable device and a computer system. The portable device comprises: means for obtaining speech data by receiving and digitizing a spoken command the command comprising a request to generate an event at the portable device; and means for transferring the speech data to a computer system; and means for providing an audible signal on the occurrence of a trigger specified by control data. The computer system comprises means for performing speech recognition on the speech data; means for identifying at least a desired trigger for an event based upon a result of the speech recognition; means for generating control data corresponding to the desired trigger; and, means for transferring the control data from the computer system to the portable device.

Another aspect of the invention provides apparatus for automatically associating context information with an event. The apparatus comprises: a portable device comprising a wireless data transceiver and means for recording an event; means for saving a list of other devices detected by way of the wireless data transceiver in response to recording the event; and means for associating the list with the recorded event.

Another aspect of the invention provides apparatus for maintaining calendar data in a computer based calendar. The apparatus comprises: a portable device comprising: a microphone; a digitizer coupled to receive and digitize speech signals captured by the microphone; and, a speaker; means for performing speech recognition on a spoken command digitized by the digitizer, the spoken command comprising a request to add data to a computer-based calendar; means for identifying at least a time for an event based upon an output from the means for performing speech recognition; means for entering the time for the event as calendar data in a computer calendar; and, means for providing an audible signal by way of the speaker of the portable device at the time for the event.

Further aspects of the invention and features of embodiments of the invention are described below.

### BRIEF DESCRIPTION OF THE DRAWINGS

In drawings which illustrate non-limiting embodiments of the invention,

FIG. 1 is a block diagram of major systems in a portable device according to an embodiment of the invention; and,

FIG. 2 is a flow chart illustrating a method for generating voice messages for implementing functions of a portable device;

FIG. 2A is a flow chart illustrating a method for automatically associating meta-data with data from an operation;

FIG. 3 is a block diagram of a portable device configured to provide a calendar function having multiple sub-calendars;

FIG. 4 is a flow chart illustrating a method for synchronizing sub-calendars between portable devices;

FIG. 5 is a block diagram of a system for providing voice actuated features in a portable device which lacks speech recognition capabilities; and,

FIG. 6 is an isometric view of a portable device.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

The invention will be described with reference to a number of example embodiments. Features of the various embodiments may be combined in various ways. A first embodiment of the invention provides a portable electronic device. The portable electronic device may comprise, for example, a laptop computer, personal digital assistant (Palm™ PDAs are one example), a cellular telephone, an electronic game, a watch, or the like. In some embodiments a user can interact with the portable device by way of an interface which accepts input from the user in the form of spoken commands and communicates information to the user in the form of sounds.

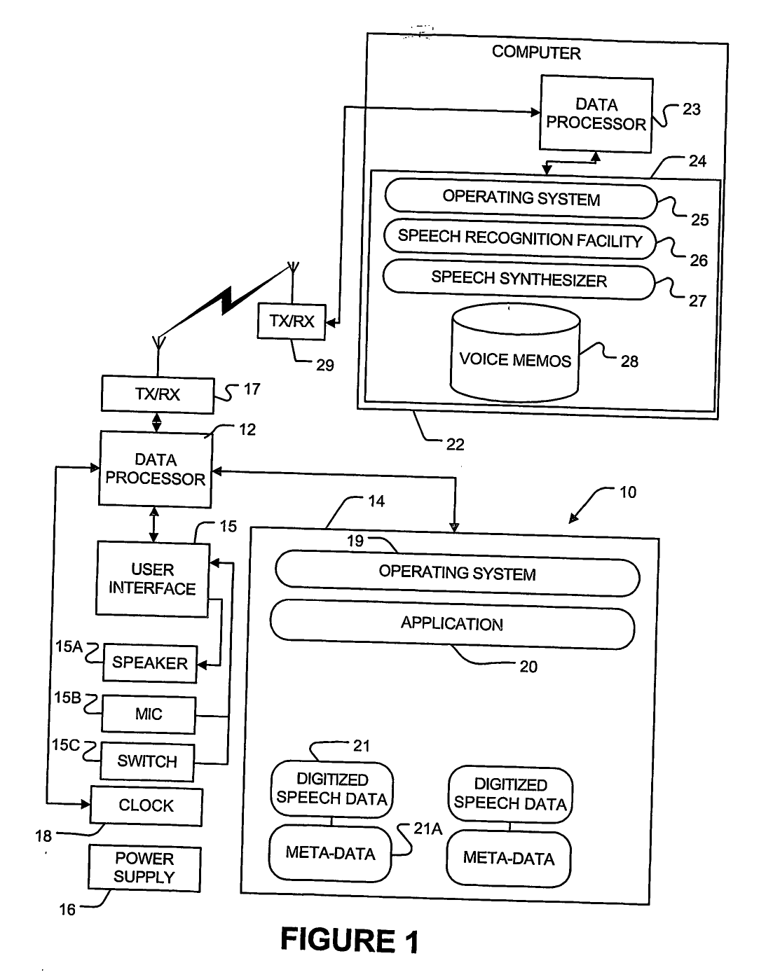

FIG. 1 illustrates a portable device 10 which is small portable and self-powered. Portable device 10 may be a “wearable” device which is easy for a user to carry around. Device 10 includes a data processor 12, such as a CPU, a memory 14, user interface 15, a power supply 16, such as a battery, and a clock 18.

User interface 15 comprises some combination of one or more visual, auditory and/or tactile transducers for communicating information to a user. In some embodiments, interface 15 comprises a speaker 15A which communicates information to a user by playing sounds, which may include digitized speech, through the speaker. In other embodiments, interface 15 comprises a display which communicates information by displaying some combination of graphics and/or text. User interface 15 also comprises a microphone 15B.

Device 10 includes some mechanism for exchanging data with other devices or with a network. In the illustrated embodiment, device 10 includes a wireless data transceiver 17. Data transceiver 17 may comprise, for example a radio transceiver, such as a Bluetooth™ radio, an infrared transceiver or the like.

The Bluetooth standard permits Bluetooth-equipped devices to initiate requests that cause other Bluetooth-equipped devices that are in range to identify themselves. In the Bluetooth specification, these requests are called “inquiries”. Various other wireless communication protocols also provide operations which are effectively inquiries but which may be commonly referred to using different terminology. Once inquiry is complete, further queries can made to get additional information about a responding device's capabilities. Such further queries may be termed “discovery” or “service discovery”. After discovery has occurred, a connection can be established to the responding device for the purpose of transferring data such as messages or files.

In some embodiments of the invention, a device 10 maintains a list of all other devices 10 it has encountered previously or all other devices 10 it has encountered within some recent time period. The list may include IDs of the other devices as well as other discoverable attributes of the other devices. A device 10 may be configured so that it only performs a full discovery of another device 10 if that other device 10 is not listed as having been previously encountered.

Since Bluetooth radio communication has a limited range, portable device 10 can only encounter another device if it is in proximity to the other device. Bluetooth typically has a range of about 10 meters. In some embodiments transceiver 17 has a range of 12 meters or less.

Where portable devices 10 include Bluetooth radio transceivers the identification information may comprise a Bluetooth address. The identification information may include text and/or digitized audio data which identifies a name or nickname for a user of portable device 10.

The invention does not require use of the Bluetooth standard. Other wireless communications protocols that are capable of exchanging identification information may be used in place of Bluetooth. For example, various protocols have been established for “zero configuration” wireless networking. Some such protocols are described in the IETF (Internet Engineering Task Force) working group “zero configuration networking”. Other protocols capable of dynamic service discovery could also be used. Portable apparatus can provide functionality according to some aspects of the invention by using a wired connection to transfer information between the portable apparatus and a network or computer. In embodiments of the invention in which the portable apparatus communicates with a remote computer system the portable apparatus may be in only sporadic communication with the remote computer system.

Processor 12 of portable device 10 executes operating system software 19. Under the control of operating system software 19, processor 12 executes application software 20. Application software 20 may have various functions.

In some embodiments, portable device 10 works in conjunction with a computer system 22 to permit a user to use voice commands to cause information to be stored into an application and/or to configure one or more applications. One such application may provide a voice memo reminder function. Since such a reminder function reasonably demonstrates this aspect of the invention it will be used as an example.

Computer 22 may have any suitable construction. Computer system 22 may comprise one or more processors in one or more housings. Computer system 22 may comprise a network in which different processors at different nodes of the network perform different parts of the functions performed by computer system 22. In the illustrated embodiment, computer system 22 comprises a data processor 23, which is in communication with a data store 24. Data store 24 contains computer programs including an operating system 25, a speech recognition facility 26, a speech synthesizer 27 and a repository 28 of voice memos. Speech recognition facility 26 and speech synthesizer 27 may respectively comprise suitable commercially available speech recognition and speech synthesis software, for example. The speech synthesis software may comprise, for example, the Microsoft™ speech API.

Computer system 22 comprises a wireless data transceiver 29 which can exchange data with wireless transceiver 17 of portable device 10, at least while data transceiver 29 is within range of data transceiver 17. Computer system 22 may, for example, comprise a personal computer used by the user of portable device 10. In an initial configuration step, software on computer system 22 may be configured to recognize and communicate with one or more specific portable devices 10.

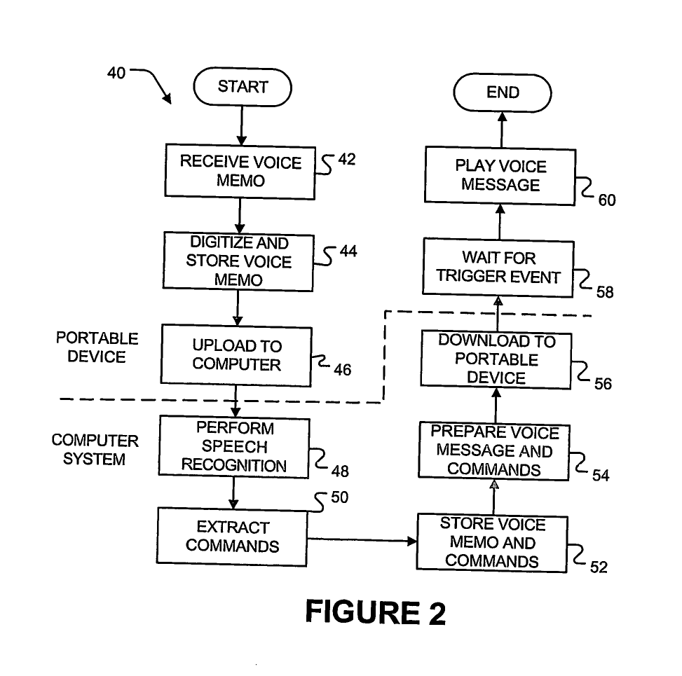

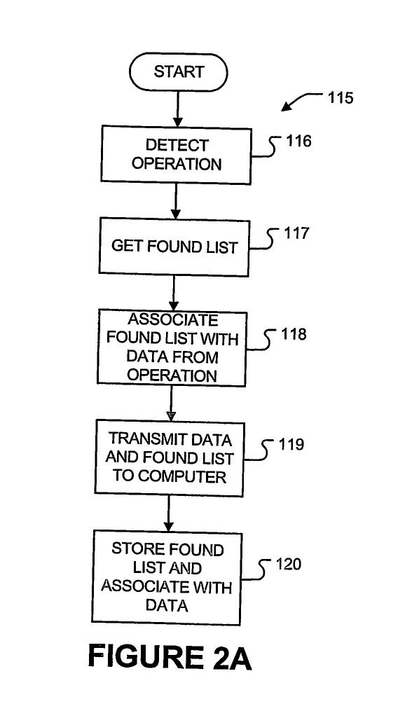

FIG. 2 illustrates a method 40 that may be performed through the use of the system of FIG. 1. Method 40 permits a user to record a spoken command which includes a voice memo and information specifying a trigger event which will cause the voice memo to be played back to the user. Method 40 begins at block 42 by receiving a voice memo. Receiving the voice memo comprises recording a user speaking into microphone 15B. The user may operate a switch 15C or other manual control to commence the recording.

In block 44 the voice memo is digitized and stored as digitized speech data in portable device 10. In block 46 the digitized speech data is uploaded to computer 22. Block 46 may be performed automatically when transceiver 17 of portable device 10 detects that it is within range of transceiver 29 of computer 22. Block 46 may occur a significant time (e.g. minutes or hours) after block 44. For example, if computer 22 is located in the user's office, block 46 may be performed each time the user carrying portable device 10 comes into the proximity of the user's office. The digitized speech data is stored until it can be uploaded to computer system 22. The digitized speech data may be automatically deleted from portable device 10 after it has been uploaded to computer system 22.

In block 48, the digitized speech is at least partially processed by speech recognition facility 26. In block 50 commands are extracted from the digitized speech. The commands comprise predetermined key words. In some embodiments, the digitized speech consists of a single utterance (e.g. a single spoken sentence which is not interrupted by prompts from portable device 10). The digitized speech may be required to have a certain syntax so that commands can be more easily recognized. As an example, the syntax may be a Backus Naur Form. For example, a memo may have the form: [Memo Command] [Time and Date] [Memo Speech]. Block 50 may detect the memo command (which may be a spoken word like “Memo” or “Reminder”) and the time and date (which may be spoken words like “March thirteenth at ten thirty a.m.” or “today at three p.m.” or the like).

In response to the memo command, block 50 knows to process the digitized speech as a memo and knows to expect a time and date. Block 50 stores the time and date extracted from the digitized speech in a computer readable format and associates it with the memo speech which, in this application, does not need to be processed further. Block 52 stores the memo speech and time and date in repository 28.

In block 54 voice memos are prepared to be downloaded to portable device 10. This involves retrieving memos to be downloaded to portable device 10 together with control information specifying the circumstances in which the memos are to be played to a user. In this example, the memo will be played at a specified time and so the control information specifies a time at which to play the memo. In some embodiments, block 54 comprises generating synthesized speech to be played back to a user either alone or together with digitized speech previously recorded by the user.

In block 56 the voice memos prepared by block 54 are downloaded to portable device 10 and stored in portable device 10 in the form of digitized speech, which can be played back over speaker 15A with minimal processing by data processor 12. In block 58 portable device 10 waits for a triggering event to occur (for example the time provided by clock 18 being a time specified by the control information associated with a memo).

Block 60 is performed upon the triggering event occurring. In block 60 portable device 10 either signals to the user that there is a voice memo to be played (for example by emitting a sound by way of speaker 15A) and waits for the user to trigger the playback of the message or simply plays the voice memo.

It can be appreciated that method 40 permits a user to enter voice commands into a portable device 10, to have those commands processed in a manner that may require significant data processing capabilities and to have portable device 10 act in response to the commands. Method 40 does not require requiring significant data processing to be performed in portable device 10.

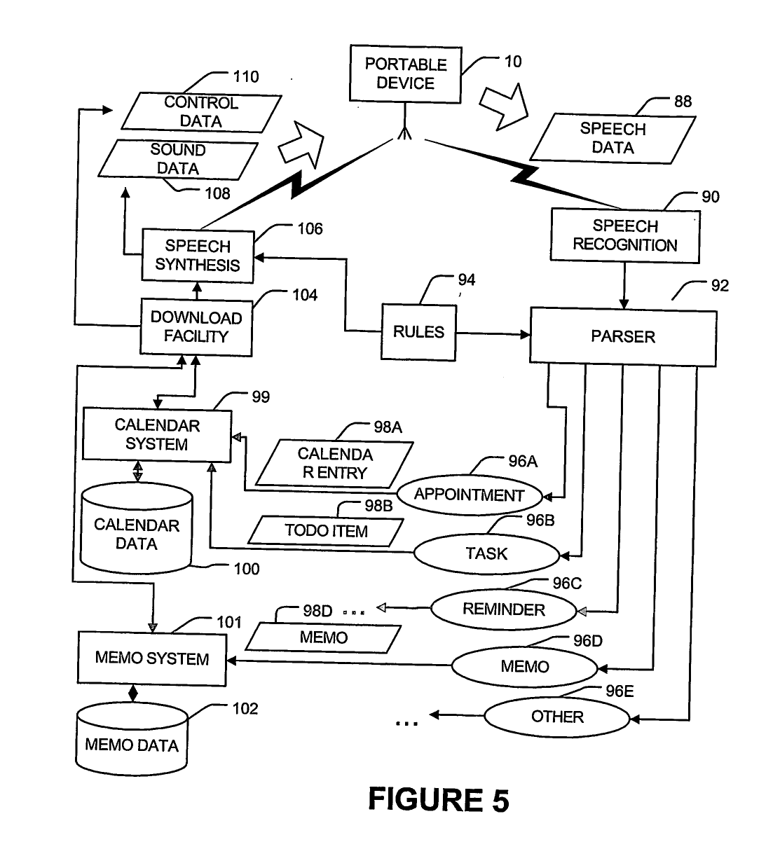

FIG. 5 illustrates a system architecture that may be used to provide various functions in response to voice-commands provided at a portable device 10. Speech data 88 is acquired at portable device 10 and delivered to a computer system as described above. In the computer system the speech data is passed to a speech recognition facility 90. The output of the speech recognition facility is provided to a parser 92.

Parser 92 first recognizes a command in the speech data that identifies a function to be performed. The command may comprise a key word which identifies the desired function. For example, the keyword “Appointment” or “Meeting” may identify the calendar function, the keyword “ToDo” may identify a task list function and so on. In some embodiments the first word of the speech data is assumed to be a keyword that identifies a function to be performed.

After parser 92 has identified a function to be performed, parser 92 looks up rules 94 which indicate the syntax expected for the function and an action to take for the function. For example, the calendar function may have a syntax: [Time/Date][Contact(s)] which expects a time and date for a meeting followed by a list of one or more contacts to be included in the meeting. The actions taken for each function are indicated in FIG. 5 by paths 96A through 96E.

In one embodiment of the invention, a function is provided for creating appointments. This function may be invoked by a speech command of the format [Appointment Command] [Date/Time] [Contact(s)]. Another function is provided for creating reminders. This function may be invoked by a speech command of the format [Reminder Command] [Time/Date] [Reminder Speech]. Another function is provided for creating encounters (i.e. proximity-based reminders). This function may be invoked by a speech command of the format [Encounter Command] [Contact] [Encounter Speech]. Another function is provided for creating tasks. This function may be invoked by a speech command of the format: [Task Command] [Task Speech].

For the calendar function of path 96A, parser 92 outputs calendar data 98A directed to a calendar system 99 which could, for example, comprise Microsoft Outlook™ software or some other suitable calendar system. Calendar system 99 saves the calendar data 98A in a calendar database 100. For the task function of path 96B, parser 92 outputs a ToDo item 98B directed to calendar system 99 (in this example, calendar system 99 provides functions for managing toDo items as well as calendar entries—many commercially available calendar systems provide functions for managing both calendar entries and lists of toDo items). For the memo function of path 96D, parser 92 generates memo data 98D directed to memo system 101. Memo system 101 saves the memo data in database 102. Other functions, such as a reminder function indicated by path 96C and the “other” function indicated by path 96E may send data to other systems (not shown in FIG. 5).

A download facility 104 prepares to upload to portable device 10 information about items from calendar system 99, memo system 101 and any other systems. Download facility 104 may select specific items to download to portable device 10. For example, download facility 104 may select appointments from calendar system 99 that are scheduled to occur sooner than a certain time in the future (for example, one week, one month, or a few days).

For each item, download facility 104 causes control information and descriptive data to be downloaded to portable device 10. The control information interacts with portable device 10 to determine circumstances under which a user will be provided with a notification corresponding to the item. The descriptive data interacts with device 10 to determine the nature of the notification. In the following example embodiment the descriptive data comprises sound data, which may include synthesized speech data.

Download facility 104 passes information about the appointments or other items to speech synthesis facility 106. Speech synthesis facility 106 provides digitized synthesized speech and/or other sound data 108 to be used to communicate information about the item to a user of portable device 10. The content of the sound data may be determined by the nature of each item. For example, where the item is a calendar entry for a meeting the sound data may comprise synthesized speech which may say “You have a meeting with [name of contact(s)] at [time]” where [name of contact(s)] is replaced with the spoken names of one or more contacts and [time] is replaced with a spoken time. In the illustrated embodiment of the invention, rules 94 include formats for the synthesized speech for the different functions.

Speech synthesis facility 106 may be controlled to synthesize speech using different voices for different functions or types of event.

Download facility 104 also provides control information 110 specifying the circumstances under which sound data 108 ought to be brought to the attention of a user. The control information may specify one or more of:

a time and date;

a certain other device to be detected by portable device 10; or

some other trigger event.

which will cause sound data 108 to be brought to the attention of a user of portable device 10.

Sound data 108 and control information 110 are automatically downloaded to portable device 10 when portable device 10 comes within range. The control information in interaction with software running on the portable device 10 causes portable device 10 to bring the sound data to the attention of a user upon the occurrence of the triggering event specified by control information 110.

In some embodiments of the invention, portable device 10 automatically detects other devices which are in its vicinity. The other devices may be discoverable through the use of a communication protocol. For example, where portable device 10 incorporates a transceiver which implements the Bluetooth™ protocol, or a similar protocol, portable device 10 may issue an “inquiry” to discover the names of nearby devices. Portable device 10 may issue inquiries to locate other devices nearby periodically and/or when portable device 10 performs a user-requested operation, such as the ones described below.

When an event occurs at portable device 10, the list of detected devices is associated with the event. Some examples of events that may occur at portable device 10 include user-requested operations such as creating an appointment, recording a digital voice memo, or other activities related to personal productivity and time management. The list of detected devices may be automatically associated in whole or in part with the event as, or as part of, meta-data 21A. Meta-data 21A may additionally include a time of the event as determined by clock 18 and other data related to the event. The list of detected devices may include identification information for the detected devices as well as information about other discoverable attributes of the detected devices.

In some embodiments of the invention, portable device 10 initiates inquiries automatically, and keeps a “found list” of other devices that respond the inquiries. When the user of device 10 records new information, e.g. a new appointment, a digital voice memo, a contact, etc. the found list is associated with the recorded event and saved. Both the recorded event and the names on the found list can be uploaded to the user's computer 22 automatically during the next synchronization cycle.

By recording information identifying nearby devices, and other discoverable attributes of nearby devices (such as device type, services, etc.), a context is provided with the operation. The context makes it easier to locate the operation at a later time. For example, a user may initiate a search in repository 28 of computer 22 for voice memos recorded while portable devices 10 of certain individuals were nearby or while a device associated with a fixed location such as a room was detected nearby. The search may be performed by any suitable searching software.

In some embodiments of the invention the portable device includes a facility for reading wireless tags, such as RFID tags attached to nearby objects. Since such tags are very compact and relatively inexpensive, such tags can be attached to portable assets such as books, reports, tools, etc. If portable device 10 includes a tag reading facility, meta-data 21A may includes a list of any tags detected by the tag reading facility as being in proximity to portable device 10 at the time of an operation.

FIG. 2A illustrates a method 115 for automatically collecting and associating with an operation performed at a device 10 a list of devices which were nearby when the operation was performed. Method 115 is triggered on the occurrence of an operation as detected at block 116. In block 117 method 115 acquires a found list containing information identifying other devices in proximity to portable device 10. The found list may be maintained by device 10 on an ongoing basis or block 117 may create a found list by discovering any nearby devices capable of communicating with portable device 10.

Where there are a large number of devices nearby, acquiring and maintaining a found list may be expedited by programming devices 10 to share found lists with one another. For example, if an arriving device 10 arrives at an area in which several other devices 10 have been located for some time, it is likely that the other devices 10 will have already discovered one another. When the arriving device 10 establishes communication with a first one of the other devices 10, the arriving device 10 may download information about all of the other devices 10. This makes it unnecessary for the arriving device 10 to separately discover all of the other devices 10. Configuring devices 10 to exchange information about other devices 10 can be achieved by suitably programming devices 10.

In block 118 the found list is associated with data from the operation. In block 119 the data and found list are transmitted to a computer system (e.g. computer system 22). In block 120 the data and found list are stored in computer system 22. In some embodiments of the invention, portable device 10 is self-contained. In such embodiments, block 119 is optional and block 120 involves storing the data and found list in portable device 10 or, optionally, in both portable device 10 and a remote computer system 22.

Devices 10 may be configured so that they do not all try to communicate at once when a large number of devices 10 are in close enough proximity to communicate with one another. There are many ways to accomplish this. For example, devices 10 may communicate a token to one another, inquiries may be suppressed or performed at a much slower rate in devices 10 which do not have the token. Devices 10 may be configured to initiate inquiries of other devices only in certain time slots, and so on.

Portable devices 10 may be capable of becoming members of a piconet, as well as having the ability to record events. The ability to inquire and discover allows devices previously unknown to one another to spontaneously form a network, known as a personal area network, or as a piconet. Portable devices 10 may maintain open connections to one another once a piconet has been established. This allows information to be rapidly shared between portable devices 10. For example, portable devices 10 in an established network may share among them selves information about arriving devices 10 which have joined the network or departing devices 10 which have left the network.

In some instances a device discoverable by portable device 10 may be associated with a physical location. For example, a device having a transceiver capable of communicating with portable device 10 may be permanently located in a certain room. In such a case the portable device 10 will include in its list of nearby devices the device associated with the room. This permits the user to search for operations which took place while the user was in or near the room.

The portable device 10 described above does not require a “find list” and can discover nearby devices which were previously unknown to it. The portable device 10 described above records the identities of nearby devices at key times, such as the time of a user-initiated operation, such as recording a digital voice memo.

In some embodiments, portable devices 10 which are proximate to one another exchange ID information which includes digitized speech identifying users of devices 10. Devices 10 include a function whereby a user can invoke software which causes the device 10 to play the digitized speech thereby reminding the user of the names of users of nearby portable devices 10.

Portable devices 10 may provide additional functions. For example, a portable device 10 may include a time tracking function. In many industries, ranging from prepress to legal, staff need to track billable hours and which accounts to bill time against. Many applications have been developed to assist this bookkeeping effort. A portable device 10, has the advantage that it can remain with a user throughout the day. A portable device 10 can acquire information about other devices in its proximity to infer additional context for the wearer's activity, either by location (library, conference room, in front of their computer) or by proximity to another person. By recording speech from the user and converting the speech to text, as described above, a portable device 10 can be used to create a log of activities and time spent.

A portable device 10 may be configured to interact with a security system, such as a card-operated door lock by exchanging signals which cause the door to open.

Portable device 10 may provide a calendar function. The calendar provides a plurality of sub-calendars. Each sub-calendar is capable of storing information relating to events. Each sub-calendar can optionally be associated with the users of one or more other portable devices who are authorized to share information with the sub-calendar. The portable devices need not be identical.

The portable electronic device includes a mechanism for causing the user interface to alert the user of the occurrence of calendar events. For example, the portable device may be configured to emit an audible signal by way of speaker 15A prior to or at the start of a scheduled event.

Each of the portable devices contains identification information. The portable devices are configured to exchange identification information amongst themselves. Where portable devices 10 include Bluetooth radio transceivers the identification information may comprise a Bluetooth address.

From the identification information exchanged between two portable devices, a first one of the portable devices can determine whether the second one of the portable devices is authorized to share information from any sub-calendars on the first portable device and vice versa. Where a portable device determines that another portable device is authorized to share data for one or more sub-calendars it exchanges information relating to the events in the one or more sub-calendar(s) with the other portable device. Data for sub-calendars that the other portable device is not authorized to share is not exchanged.

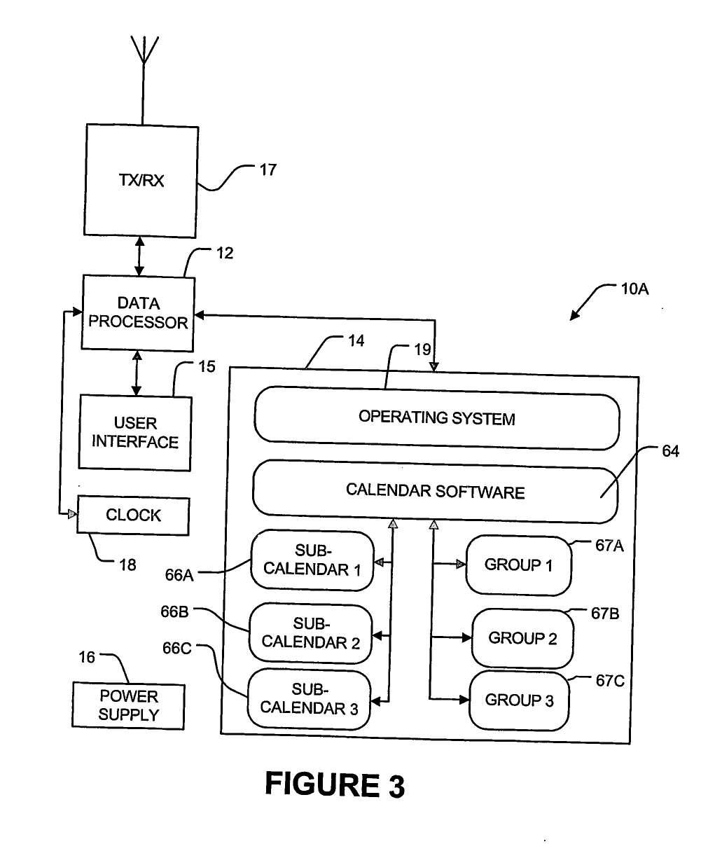

One embodiment of the invention is shown in FIG. 3. Portable device 10A of FIG. 3 is small portable and self-powered. Device 10A is constructed substantially similarly to device 10 of FIG. 1 and may be the same as the device 10 of FIG. 1. In device 10A, processor 12 executes calendar software 64. Calendar software 64 has access to a plurality of sub-calendars 66. In the illustrated embodiment of the invention there are three sub-calendars 66A, 66B and 66C. There are typically three or more sub-calendars 66. Each sub-calendar 66 includes a set of zero or more events which are associated with the sub-calendar. Each event comprises stored information which specifies at least a start time and date, a duration and some information about the event.

Each sub-calendar may relate to a category of events. Sub-calendars may be provided for different collections of events that share a common attribute, e.g. a collection of events relating to personal time may be grouped in one sub-calendar, collections of events relating to different sports activities may each be grouped in a sub-calendar, events relating to meetings of a certain group may be grouped in a sub-calendar, events relating to a particular project may be grouped in a sub-calendar, events relating to business trips may be grouped in a sub-calendar, and so on.

For each sub-calendar, portable device 10A stores information 67 identifying the members of a group of others who are authorized to share information in the sub-calendar. There may be a one-to one relationship between groups 67 and sub-calendars 66 as shown in FIG. 1. FIG. 1 shows groups 67A, 67B and 67C. In the alternative, there may be a one-to-many relationship or a many-to-many relationship between groups and sub-calendars. Information 67 includes identification information for the portable devices 10A of the members of each group. Information 67 may include, for example, the Bluetooth addresses of portable devices 10A carried by each member of the group.

The definition of sub-calendars 66 and the association of a group of users associated with each sub-calendar 66 may be performed by a user using functions of master calendar software running on a PC or network. The information constituting sub-calendars 66 and group information 67 may be downloaded to the portable electronic device 10A during synchronization with the master calendar software.

Portable devices 10 may include a security mechanism which prevents their use by anyone but an authorized user. The security mechanism may comprise authorization software which requires a password before device 10 will permit access to stored information by way of the user interface, a biometric identification mechanism such as a fingerprint or eye scanner, a mechanical or electronic key, or the like.

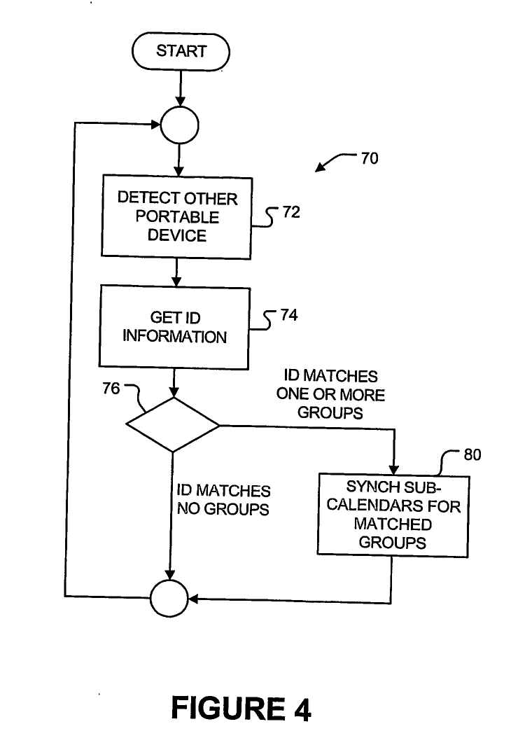

As shown in FIG. 4, each portable device 10A performs a method 70. In block 72 device 10A detects other portable devices 10A which are within its range by way of wireless interface 17. Subsequently, in block 74 the device 10A obtains information (“ID”) identifying another portable device. Device 10A then compares the ID of the other device with the information in groups 67 (block 76). If the ID of the other device has no match in any of groups 67 then method 70 waits until another portable device comes into range.

If block 76 determines that the ID of the other device has a match in any of groups 67 then, in block 80, portable device 10A synchronizes with the other device those of its sub-calendars 66 for which there is a match for the ID of the other device in the corresponding group information 67. Two devices 10A may synchronize things other than sub-calendars. For example, the devices may synchronize time, sounds, reminders, and shared files.

Example Calendar Application

Suppose a person “P” has a portable device 10A as described above. Using calendar software on a PC, P has created several sub-calendars and has associated each of the sub-calendars with a group of other people. P puts the names and email addresses of his soccer team in a list of people who can share his “soccer” sub-calendar who then become his “soccer group”. P's calendar software looks up in a directory available to P's PC the IDs of portable electronic devices corresponding with each person in the “soccer group”. P associates his spouse's and children's names and email addresses with his “outside office hours” sub-calendar thus creating an “outside office hours group”. For each person in each group the calendar software obtains from a data store accessible to the calendar software identification information for a portable device 10 carried by the person. P's calendar software looks up in a directory available to P's PC the IDs of portable electronic devices corresponding with each person in the “soccer group”.

P's calendar may show that from 3:00-5:00 p.m. on a particular date he has a meeting with his colleagues in the office, while at 5:30 p.m. he has a soccer practice, and on the next day he has a dinner meeting with a client from 6 p.m. to 9 p.m. He places the soccer practice into the “soccer” category so that the soccer practices and games are in the soccer sub-calendar. He places the client dinner in the “outside office hours” category so that the client dinner is in the outside office hours sub-calendar. P is in charge of scheduling games for his soccer league and so he adds to the soccer sub-calendar a new entry for a soccer game from 8:00 a.m. to 10:30 a.m. three days hence.

P then synchronizes his portable device 10A with the calendar maintained on his PC. This synchronization includes providing data from the PC to the portable device 10A in any suitable manner. For example, P's PC may establish a wireless connection to P's portable device 10A or P may connect an interface cable between the PC and the portable device 10A. In some embodiments of the invention, P's device 10A automatically establishes wireless communication with P's PC and synchronizes the calendar information in P's portable device 10A with the information of the calendar in P's PC each time P's device 10A comes into wireless communication range of P's PC.

During synchronization, portable device 10A receives information regarding events scheduled in each of P's sub-calendars and also the identification information for the portable devices 10A carried by the persons in the group corresponding to each sub-calendar. During synchronization, portable device 10A may receive information specifying a current time and may re-set clock 18 based upon such time information.

This aspect of the invention recognizes that there are times when two or more members of the same group may encounter one another before they are near their personal computer, which is normally where they would receive updated schedule information. When P's portable device 10A encounters another portable device 10A and recognizes the owner of another portable device as being a member of a group, it synchronizes only those calendar events of the corresponding sub-calendar with the other portable device 10A. Peer calendar updates as outlined here allow faster notification of potentially relevant scheduled events or changes to previously scheduled events, than waiting to synchronize a mobile device with a personal computer.

In this example, each of P's children carry their own portable devices 10A. When P comes into proximity with one of his children, so that the child's device 10A is in range of P's device 10A, P's device 10A discovers that it is in communication with the device 10A of a person in the “outside office hours” category. Consequently, P's device 10A and the child's device 10A synchronize their “outside office hours” sub-calendars. P's client dinner is subsequently present in the child's device 10A.

The next day P goes to his soccer practice where he encounters various members of his soccer team. The soccer team members each carry a portable device 10A and are all members of P's soccer group. When P comes into proximity with each soccer team member, so that the soccer team member's device 10A is in range of P's device 10A, P's device 10A discovers that it is in communication with the device 10A of a person in the “soccer” category. Consequently, P's device 10A and the device 10A of the soccer team member synchronize their “soccer” sub-calendars. The soccer game from P's soccer sub-calendar is subsequently present in the soccer team member's device 10A. The information from P's soccer sub-calendar can be further disseminated when those persons meet other persons who belong to the soccer group. Information in P's other sub-calendars are not exchanged with members of the soccer group except in the case where a member of the soccer group is also a member of a group 67 associated with a different one of P's sub-calendars 66.

As P goes about his daily affairs and comes into range of other people who belong to various of P's groups 67, P's device 10A shares information from corresponding ones of its sub-calendars 66 with the devices 10A carried by those persons.

At the end of the day, or at any other suitable time, P once again synchronizes his portable device 10A with the calendar maintained by calendar software on P's PC. During this synchronization, P's portable device 10A transmits to P's PC information specifying any new events in P's sub-calendars that P's portable device 10A has obtained from other portable devices 10A that P has encountered. The calendar software on P's PC may check for conflicts in P's schedule and apply conflict resolution rules and/or prompt P to resolve any conflicts.

Example of a Specific Embodiment

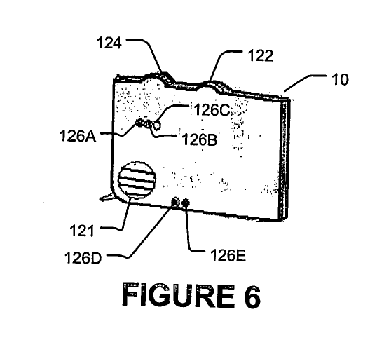

FIG. 6 shows a device 10 according to a specific embodiment of the invention, device 10 lacks a screen or keyboard. This makes it practical to make device 10 small enough to be worn constantly so that it is there when needed. The device 10 could, for example, have dimensions of about 2.8″ (72 mm) by 1.8″ (46 mm) by 0.3″ (7.5 mm) thick, making it about 1/15 the size of a Pocket-PC cellular telephone. A user can interact with this embodiment of device 10 primarily through touch, sound, and sight.

Device 10 has an onboard speaker 121 driven by a suitable amplifier which generates audio signals to alert its user by providing reminders, proximity alerts, and warnings. The speaker can also play other sounds such as synthesized speech. An alert sound signals to the user that a spoken announcement is awaiting a chance to speak.

In this example embodiment of device 10, transceiver 17 is a Bluetooth™ transceiver which can maintain wireless communication with a headset. When a headset is present, device 10 can receive audio input from and direct audio output to the headset rather than use the built-in speaker and microphone. When a headset is paired to the device 10, applications may deliver voice messages immediately after sounding an alert tone instead of pausing for permission.

A portable device 10 may be configurable to behave as a Bluetooth-enabled cell or land phone. This is particularly feasible where such devices are equipped with a headset. Other people wearing portable devices 10 or other Bluetooth-enabled headsets may join in a conference call. Signal processing may be performed locally on a digital signal processor (DSP) in each portable device 10. Providing each person with a unique microphone and headset can greatly improve the quality of a collaborative conference call.

Where a portable device 10 comprises a telephone, device 10 may include a caller display feature. In this case, a telephone call to or from a contact, as identified by the caller display function, may be treated in the same manner as an encounter with the contact. The telephone call may therefore trigger making available a proximity-based reminder to a user of portable device 10.

A user can control operation of device 10 by way of one toggle, 122 and one thumbwheel 124. Toggle 122 enables stepping and thumbwheel 124 enables scrolling. Scrolling and stepping use either a “forward/backward,” usually for time, or and “up/down,” or “next/previous” metaphor, usually for proceeding through a list. Toggling selects the “next” or “previous” application resident on device 10 that has user-selectable features. Examples are “reminder,” “memo,” and “sound”.

Toggle 122 may be used as a play/record/pause button, to signal device 10 when it is allowed to speak, or should cease speaking. Holding toggle 122 down for more than one second acts as a shortcut to a memo application, i.e. it acts as if the user had used toggle 122 to shift to the memo application, and begins to record a new memo.

Scroll wheel 124 acts in an analogous manner to the tuning knob of an old radio. Turning scroll wheel 124 slowly advances one step at a time. Spinning scroll wheel 124 more quickly advances more quickly through a list. Each time scroll wheel 124 is advanced, a sound is played which provides feedback to the user as to the speed at which scrolling is occurring. Scroll speed may be nonlinear, providing much faster scrolling when the velocity of the scroll wheel is high. Nonlinear scrolling allows a user of device 10 to listen to appointments a few hours or a few months away by receiving feedback as to where scroll speed sets the time.

The actual sound played in response to motion of scroll wheel 124 depends on the application. By default, “scroll up/scroll down” sounds specified by operating system 19 are played. Such sounds might be, for example, short clicks. Applications can override this sound, for example a reminder may override the scroll sound by playing the time of the next/previous appointment. Pressing scroll wheel 124 plays the complete reminder corresponding to the time that was set by scrolling.

Scroll wheel 124 may be associated with a control (not shown) which may be used to toggle the meaning of the scroll wheel to a volume control. When in volume control mode, scrolling plays the “click” system sound at appropriately higher or lower volumes.

This example embodiment of device 10 has five light-emitting diodes or other lamps 126 (individually labeled 126A through 126E). Lamps 126A, 126B and 126C are under software control. Lamp 126D provides a low battery warning. Lamp 126E indicates a charging status of the batteries of portable device 10. Lamps 126A, 126B, and 126C, may be different colors, for example, green, blue and orange. The lamps under software control preferably come on and turn off in a smooth, ramping up manner, softly transitioning from off to on, rather than the typical digital mode of being 100% on or off. The lamps may be flashed to communicate information to a user. Software programs may control each lamp to flash by specifying a transition time (Δ), duration (τ), and period (T).

Lamps 126A through 126C may indicate status information. For example, green lamp 126A may be flashed to indicate that device 10 is synchronizing one or more sub-calendars with another device 10, blue lamp 126B may flash to indicate an encounter with another device 10 and orange lamp 126C may flash to indicate that device 10 is recording.

Green lamp 126A may be controlled to begin pulsing only after device 10 has determined that new information is available since the last synchronization operation. Green lamp 126A may be controlled to stop pulsing once device 10 is in sync. This provides a visual indicator to the wearer when synchronization is running, and when it has finished. Since synchronization may be initiated every few minutes, this protocol also prevents misleading a user that the device is out of synchronization when it is really just verifying that it is actually up-to-date.

Encounters relate to discovery of another device (such as a PC, or another device 10) which is aware of and can communicate with device 10. During an encounter, blue lamp 126B may be operated to provide 250 ms pulses at a period of 30 seconds. During audio recording, orange lamp 126C may be operated to provide 100 ms pulses, at a period of 15 seconds.

The device 10 of this example can be controlled using a control panel application running on a PC. The control panel application (mcp) performs two functions: it provides a user interface to control the settings of a particular device 10 and it also provides a background service that detects devices 10, and synchronizes them with information in the PC.

Device 10 may have a number of software applications in addition to a calendar. For example, device 10 may run a reminder application. Reminder is a memory-assist application that prompts the user of device 10 to remember things at times, places or near other people which make the reminder appropriate. The reminder application may provide proximity-based reminders. A proximity-based reminder may be called an encounter. Since device 10 can discover other devices it can use the fact that it is in proximity to another device 10 to remind the user of actions or to-do items appropriately. Placing a device 10 in a meeting room or other location makes it possible to use the fact of being in a particular room as a key to retrieve reminders. For example, a user might set the reminder function of the user's device 10 to remind the user to look for a lost coffee cup when the user is in a certain conference room, or to remind the user to tell another person that the user has some pictures to show the other person when the user encounters the other person.

In some embodiments, portable device 10 plays an encounter sound when it senses that it is proximate to the person or place for which a reminder is to be provided. Sometimes the encounter sound may occur at an inconvenient time or the user may not notice the encounter sound for some reason. Portable device 10 may remind the user by playing the encounter sound each time portable device 10 is in proximity to the person or place until the user acknowledges encounter event. To acknowledge an encounter event, the user may listen to the encounter sound clip by pressing scroll wheel 124 down.

When a user acknowledges an encounter, portable device 10 may note information about the encounter such as a time the encounter was acknowledged and a list of other devices in proximity at the time of the acknowledgment. This information may be stored in device 10 and later uploaded to computer system 22 which may associate the information about the encounter with a record of the original reminder.

When the reminder application wakes up to tell the user of a reminder event, it becomes the selected application, i.e. it acts as if the user had used the application toggle to move to the reminder application. When reminder is the selected application, the toggle button operates as a play/pause control. The reminder that gets played as the “current” appointment is available between the time of the reminder (“n” minutes before the appointment) up the next reminder. Scroll wheel 124 operates as a next/previous appointment selector.

Device 10 calculates the rate of spin of scroll wheel 124 to determine how far back/ahead in time to select a reminder from. Once the scroll wheel has not been moved for a short time, such as about 300 msec, device 10 plays the time of the then current reminder. Pressing the “play” button then plays out the entire reminder, i.e. title, location, etc.

Device 10 may have a memo application. A memo application makes use of a microphone to record audio segments. The audio segments may later be uploaded to a personal computer for later use. More advanced memo functionality allows the user to set a category for any recording, such as a to-do item, an email or voice-mail, or a reminder event. Choosing kinds of memos may be achieved using a limited voice-command recognition system resident on device 10. When memos are uploaded to a home personal computer the audio segments may be passed through a speech-to-text converter. The resulting text and audio file are attached and are both available on the PC. When the speech recognition identifies an email, it composes the text into an email ready for sending, while a reminder event creates a toDo item.

When it is the selected application, the play/pause button becomes record/pause. Pressing record starts recording and initiates the led flashing to indicate recording. Pressing and holding the toggle button down for a short time, for example, more than about 1 second in any state of the device 10 selects the memo application and begins recording a new memo. Device 10 signals audibly with a warning tone when the available storage is low. Recording lamp 126C does not flash unless the recording is being saved to non-volatile storage.

Scroll wheel 124 is disabled during recording, i.e. it has no effect until the recording is paused. Scrolling moves forward and back in the recorded memo list. If scroll wheel 124 has not been moved for a short time, such as 300 ms, device 10 begins to play the selected memo. Scrolling while a memo is playing immediately stops playback of the memo. If the user presses the record button 124, device 10 appends the new recording to the current memo. Successful uploading of memos to the user's PC may cause device 10 to erase the memos from its memory.

The “sound” application may override the scroll sound by actually playing each sound in a sound library of device 10. A user may use the scroll wheel to move back and forth through the sounds. Sound play is interruptible—scrolling to another sound while one is playing immediately replaces the playing sounds with the new sound.

A portable device 10 may include security mechanisms which prevent its use by anyone but an authorized user. The security mechanisms may comprise authorization software which requires a password before device 10 will permit access to stored information by way of the user interface, a biometric identification mechanism such as a fingerprint or eye scanner, a mechanical or electronic key, or the like.

In some embodiments of the invention, portable device 10 includes a speech recognition facility and/or a speech synthesis facility. These facilities may be used to perform the functions described above. These facilities may be in the form of suitable software which is executed on a processor of the portable device. Where speech recognition and speech synthesis facilities are provided in device 10 then various of the methods described above may be performed by device 10 in a self-contained manner.

Certain implementations of the invention comprise computer processors which execute software instructions which cause the processors to perform a method of the invention. For example, portable device 10 may comprise a computer processor which executes software instructions which cause the processor to perform methods as described above. The invention may also be provided in the form of one or more program products. The program products may comprise any medium which carries a set of computer-readable signals comprising instructions which, when executed by a computer processor, cause the data processor to execute a method of the invention. The program product may carry computer instructions to be executed on either or both of portable device 10 and computer system 22. The program product may be in any of a wide variety of forms. The program product may comprise, for example, physical media such as magnetic data storage media including floppy diskettes, hard disk drives, optical data storage media including CD ROMs, DVDs, electronic data storage media including ROMs, flash RAM, or the like or transmission-type media such as digital or analog communication links.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

1-73. (canceled)

74. Apparatus for controlling a function provided at least in part by way of a portable electronic device, the apparatus comprising:
a portable device comprising:
means for obtaining speech data by receiving and digitizing a spoken command the command comprising a request to generate an event at the portable device;
means for transferring the speech data to a computer system; and means for providing an audible signal on the occurrence of a trigger specified by control data; and,
a computer system comprising:
means for performing speech recognition on the speech data;
means for identifying at least a desired trigger for an event based upon a result of the speech recognition;
means for generating control data corresponding to the desired trigger; and,
means for transferring the control data from the computer system to the portable device.

75. Apparatus according to claim 74 wherein the means for transferring the speech data to the computer system and the means for transferring the control data to the portable device comprise a wireless communication channel.

76. Apparatus according to claim 74 wherein the portable device comprises a clock and a means for comparing a current time to a time specified by the control data.

77. Apparatus according to claim 74 wherein the computer system comprises a speech synthesizer.

78. Apparatus according to claim 77 wherein the speech synthesizer comprises a plurality of synthesized voices and the computer system comprises a means for selecting one of the plurality of synthesized voices based upon a result of the speech recognition.

79. Apparatus according to claim 74 wherein the computer system comprises means for identifying one of a plurality of functions based upon an output of the means for speech recognition.

80. Apparatus according to claim 78 wherein the computer system comprises means for identifying one of a plurality of functions based upon an output of the means for speech recognition and means for selecting one of the plurality of voices based upon the identified function.

81. Apparatus according to claim 79 wherein the computer system comprises a calendar facility.

82. Apparatus according to claim 74 wherein the portable device comprises means for automatically detecting one or more other devices that are proximate to the portable device and means for associating a list of the one or more other devices with the speech data.

83. Apparatus according to claim 82 wherein the computer system comprises:
a database comprising records of one or more events associated with speech data and corresponding lists of other devices; and,
means for searching the database for records at least in part according to the corresponding lists of other devices.

84. Apparatus according to claim 83 comprising a plurality of other devices each having a fixed location.

85. Apparatus according to claim 74 wherein the computer system comprises:
means for identifying one of a plurality of functions based upon a output from the means for speech recognition; and,
means for parsing the output of the means for speech recognition according to a rule selected on the basis of the identified function.

86. Apparatus according to claim 85 wherein the means for identifying the one of the plurality of functions comprises means for recognizing a keyword in the speech data.

87. Apparatus according to claim 86 wherein the means for recognizing a keyword comprises means for identifying a keyword occurring at a beginning of the speech data.

88. Apparatus for automatically associating context information with an event, the apparatus comprising:
portable device comprising a wireless data transceiver and means for recording an event;
means for saving a list of other devices detected by way of the wireless data transceiver in response to recording the event; and means for associating the list with the recorded event.

89. Apparatus according to claim 88 comprising means for uploading the recorded event and the saved list to a computer system.

90. Apparatus according to claim 89 comprising a computer system, the computer system comprising means for storing the recorded event and the saved list in a data store and maintaining an association between the recorded event and the saved list.

91. Apparatus according to claim 90 wherein the computer system comprises means for conducting a search for the recorded event in the data store based at least in part on information in the stored list.

92. Apparatus according to claim 88 wherein the portable device comprises means for digitally recording sound.

93. Apparatus for maintaining calendar data in a computer based calendar, the apparatus comprising:
a portable device comprising: a microphone; a digitizer coupled to receive and digitize speech signals captured by the microphone; and, a speaker;
means for performing speech recognition on a spoken command digitized by the digitizer, the spoken command comprising a request to add data to a computer-based calendar;
means for identifying at least a time for an event based upon an output from the means for performing speech recognition;
means for entering the time for the event as calendar data in a computer calendar; and,
means for providing an audible signal by way of the speaker of the portable device at the time for the event.

94. Apparatus according to claim 93 wherein the audible signal comprises digitized speech.

95. Apparatus according to claim 94 wherein the digitized speech comprises at least a portion of the digitized spoken command captured by the microphone.

96. Apparatus according to claim 93 wherein the means for performing speech recognition is located at a computer system outside of the portable device.

97. Apparatus according to claim 96 wherein the computer system comprises a calendar database and the means for entering the time for the event is configured to store the time for the event in the calendar database.

98. Apparatus according to claim 96 comprising a wireless data link linking the portable device and the computer.

99. Apparatus according to claim 94 comprising a computer system outside of the portable device wherein the computer system comprises a speech synthesizer connected to generate at least some of the digitized speech.

100. (canceled)

101. (canceled)
